(19) United States
(12) Patent Application Publication
(10) Pub. No.: US 2025/0181970 A1
(43) Pub. Date: Jun. 5, 2025

(54) INFORMATION PROCESSING SYSTEM

(71) Applicant: TOYOTA JIDOSHA KABUSHIKI KAISHA, Toyota-shi (JP)

(72) Inventors: Naoki ISHIHARA, Nisshin-shi (JP); Naritomo MIURA, Miyoshi-shi (JP); Shinya MIYASAKA, Okazaki-shi (JP)

(73) Assignee: TOYOTA JIDOSHA KABUSHIKI KAISHA, Toyota-shi (JP)

(21) Appl. No.: 18/785,536

(22) Filed: Jul. 26, 2024

(30) Foreign Application Priority Data
Dec. 1, 2023 (JP) 2023-203924

(51) Int. Cl. G06N 20/00; H04L 67/1097

(52) U.S. Cl. CPC G06N 20/00; H04L 67/1097

(57) ABSTRACT

The information processing system includes a first distributed network for implementing a first distributed ledger. A first transaction about relevance information indicating relevance between one learned model and either or both of learning data and a first source code that are used for learning of the one learned model is stored in the first distributed ledger.

### CROSS-REFERENCE TO RELATED APPLICATION

This application claims priority to Japanese Patent Application No. 2023-203924 filed on Dec. 1, 2023, incorporated herein by reference in its entirety.

### BACKGROUND

### 1. Technical Field

The present disclosure relates to the technical field of information processing systems.

### 2. Description of Related Art

For example, a system has been proposed that stores information about each manufacture or transaction case of business operators constituting a supply chain in a distributed ledger to manage information about defects of products etc. that occurred in the supply chain while preventing falsification (see Japanese Unexamined Patent Application Publication No. 2021-002129 (JP 2021-002129 A)).

### SUMMARY

For example, there are cases where information about one learned model and information about both learning data and a source code that are used to construct the one learned model by machine learning are registered in a distributed ledger. The learned model and the learning data and source code may be registered in different distributed ledgers. In this case, there is a technical issue that the relevance between the one learned model and the learning data and source code becomes unknown.

The present disclosure was made in view of the above issue, and an object of the present disclosure is to provide an information processing system that can save information indicating relevance between one learned model and either or both of learning data and a source code.

An information processing system according to an aspect of the present disclosure includes
a first distributed network that implements a first distributed ledger.

A first transaction is stored in the first distributed ledger. The first transaction is a transaction about relevance information indicating relevance between one learned model and either or both of learning data and a first source code that are used for learning of the one learned model.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of an information processing system according to an embodiment; and

FIG. 2 is a conceptual diagram illustrating a concept of a distributed ledger.

### DETAILED DESCRIPTION OF EMBODIMENTS

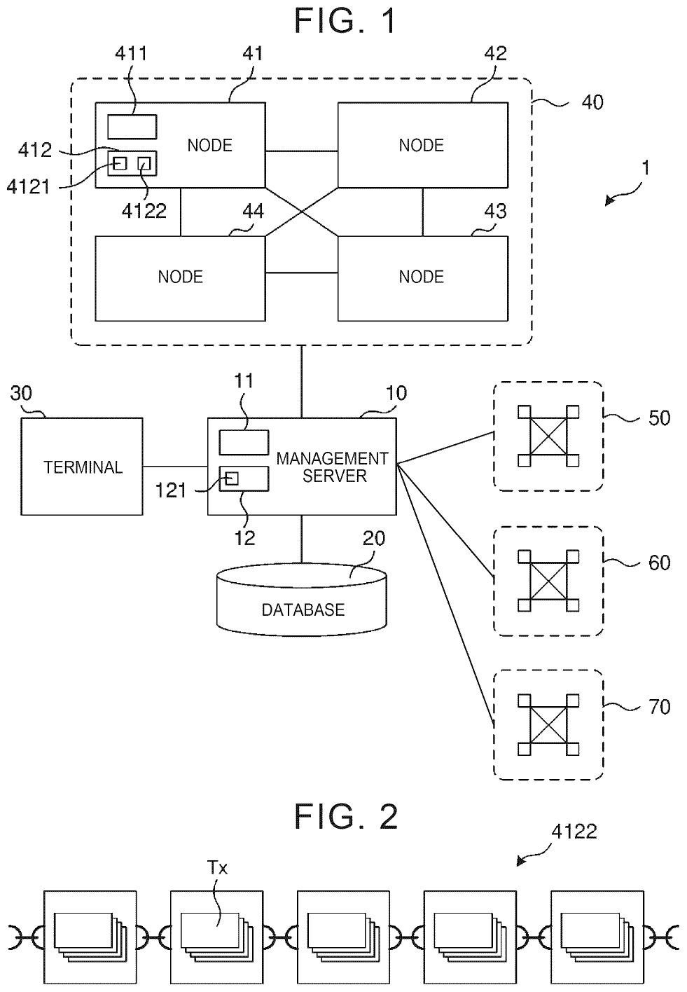

An embodiment of an information processing system will be described with reference to FIGS. 1 and 2. FIG. 1 is a block diagram illustrating a configuration of an information processing system 1. FIG. 2 is a conceptual diagram illustrating a concept of the distributed ledger 4122.

In FIG. 1, the information processing system 1 includes a management server 10, a database 20, a terminal 30, and distributed networks 40, 50, 60, and 70. Each of the distributed networks 40, 50, 60, and 70 is a network for realizing a distributed ledger. In the present embodiment, a blockchain is exemplified as an example of a distributed ledger. The terminal 30 may be connected to the management server 10 via a wide area network such as the Internet.

The distributed network 40 has nodes 41, 42, 43, and 44. The number of nodes included in the distributed network 40 is not limited to “4”. The node 41 may include a processor 411 and a memory 412. The memory 412 may store a computer program 4121. The processor 411 may execute processing to be performed by the node 41 together with the memory 412 in which the computer program 4121 is stored (in other words, together with the memory 412 and the computer program 4121 stored in the memory 412). For example, the processor 411 may execute the computer program 4121 to implement logical functional blocks in the processor 411 for executing processing to be performed by the node 41. The memory 412 of the node 41 may store a distributed ledger 4122 implemented by the distributed network 40 (in other words, constructed in the distributed network 40). As shown in FIG. 2, one or more transactional Tx may be stored in the distributed ledger 4122. Note that the configuration of the nodes 42, 43, and 44 may be the same as the configuration of the node 41.

The distributed network 50 includes a plurality of nodes. Note that the configuration of the plurality of nodes included in the distributed network 50 may be the same as the configuration of the node 41. For example, a transaction related to a learned model may be stored in a distributed ledger realized by the distributed network 50. For example, the transaction for the learned model may include identification information for identifying the learned model. An example of the identification information for identifying the learned model is a hash value generated from the learned model. In this case, the learned model may be registered in the database 20. For example, a transaction for a learned model may include a learned model. In this case, the learned model may not be registered in the database 20. The learned model may be, for example, a learned model applicable to an automated driving system of a vehicle. The learned model may be, for example, a learned model applicable to a navigation device. The learned model is not limited to a learned model applicable to either or both of the automated driving system and the navigation device.

The distributed network 60 includes a plurality of nodes. Note that the configuration of the plurality of nodes included in the distributed network 60 may be the same as the configuration of the node 41. For example, a transaction related to learning data may be stored in a distributed ledger realized by the distributed network 60. For example, the transaction related to the learning data may include identification information for identifying the learning data. An example of the identification information for identifying the learning data is a hash value generated from the learning data. In this case, the learning data may be registered in the database 20. For example, the transaction related to the learning data may include the learning data. In this case, the learning data may not be registered in the database 20.

The distributed network 70 includes a plurality of nodes. Note that the configuration of the plurality of nodes included in the distributed network 70 may be the same as the configuration of the node 41. For example, in the distributed ledger realized by the distributed network 70, a transaction related to a learning source code (that is, a source code for constructing a learned model by machine learning using learning data) may be stored. For example, the transaction related to the training source code may include identification information for identifying the training source code. An example of the identification information for identifying the learning source code is a hash value generated from the learning source code. In this case, the learning source code may be registered in the database 20. For example, the transaction related to the learning source code may include the learning source code. In this case, the learning source code may not be registered in the database 20.

Note that at least one node of the plurality of nodes (for example, the nodes 41, 42, 43, and 44) included in the distributed network 40 may constitute at least one node of the distributed networks 50, 60, and 70. At least one of the plurality of nodes included in the distributed network 50 may constitute at least one node of the distributed networks 40, 60, and 70. At least one of the plurality of nodes included in the distributed network 60 may constitute at least one node of the distributed networks 40, 50, and 70. At least one of the plurality of nodes included in the distributed network 70 may constitute at least one node of the distributed networks 40, 50, and 60.

The management server 10 may include a processor 11 and a memory 12. A computer program 121 may be stored in the memory 12. The processor 11 may execute processing to be performed by the management server 10 together with the memory 12 in which the computer program 121 is stored (in other words, together with the memory 12 and the computer program 121 stored in the memory 12). For example, by the processor 11 executing the computer program 121, logical functional blocks for executing processing to be performed by the management server 10 may be realized in the processor 11.

The management server 10 may provide the terminal 30 with an application for browsing a distributed ledger realized by at least one of the distributed networks 40, 50, 60, and 70, and an application for accessing the database 20. Therefore, the management server 10 may be referred to as an application server.

For example, an operation of the information processing system 1 in a case where the user of the terminal 30 registers one learned model, one learning data (set) used for learning the one learned model, and one learning source code will be described.

The user may instruct the management server 10 to register one learned model, one learning data, and one source code for learning via the terminal 30. In this case, the processor 11 of the management server 10 may generate a transaction related to one learned model, a transaction related to one learning data, and a transaction related to one learned source code.

The transaction for one learned model may be stored in a distributed ledger implemented by the distributed network 50 by one node of the distributed network 50. The transaction related to one learning data may be stored in a distributed ledger realized by the distributed network 60 by one node included in the distributed network 60. The transaction related to one learning source code may be stored in a distributed ledger realized by the distributed network 70 by one node included in the distributed network 70.

The processor 11 may further generate a transaction related to the relevance information indicating the relevance between the one learned model, the one learning data, and the one source code for learning. The transaction relating to the relevance information may include information relating to one learned model, information relating to one learning data, and information relating to one learned source code. That is, the relevance between one learned model, one learning data, and one learned source code may be indicated by the transaction related to the relevance information including information about one learned model, information about one learning data, and information about one learned source code. For example, the processor 411 of the node 41 of the distributed network 40 may store the transaction related to the relevance information in the distributed ledger 4122 realized by the distributed network 40.

Note that the user may instruct the management server 10 to register one learned model and one learning data via the terminal 30. In this case, the processor 11 of the management server 10 may generate a transaction related to the relevance information indicating the relevance between the one learned model and the one learning data. Note that the user may instruct the management server 10 to register one learned model and one source code for learning via the terminal 30. In this case, the processor 11 of the management server 10 may generate a transaction related to the relevance information indicating the relevance between one learned model and one source code for learning. Note that the user may instruct the management server 10 to register one learning data and one learning source code via the terminal 30. In this case, the processor 11 of the management server 10 may generate a transaction related to the relevance information indicating the relevance between one learning data and one learning source code.

For example, an operation of the information processing system 1 in a case where a user of the terminal 30 makes a query of one learned model will be described.

The user may instruct the management server 10 to query one learned model via the terminal 30. In this case, the processor 11 of the management server 10 may read the distributed ledger 4122 realized by the distributed network 40. Based on the result of reading the distributed ledger 4122, the processor 11 may provide, to the terminal 30, information related to either or both of learning data related to one learned model and learning source code related to one learned model, together with information related to one learned model.

The processor 11 may further read a distributed ledger implemented by the distributed network 50. In this case, the processor 11 may provide the terminal 30 with information indicated by a transaction related to one learned model stored in the distributed ledger realized by the distributed network 50 as at least a part of the information related to the one learned model.

### Technical Effect

For example, a transaction related to one learned model, a transaction related to one learning data, and a transaction related to one learned source code may be stored in different distributed ledgers. In this case, if no countermeasure is taken, there is a possibility that the relevance between one learned model, one learning data, and one learned source code is not known. On the other hand, in the information processing system 1, a transaction related to the relevance information indicating the relevance between one learned model and one learning data and one source code for learning is stored in the distributed ledger 4122. Therefore, in the information processing system 1, by the user reading the distributed ledger 4122 via the terminal 30, it is possible to confirm the relevance between one learned model, one learning data, and one learned source code. Therefore, according to the information processing system 1, it is possible to save information indicating relevance between one learned model, one learning data, and one source code for learning.

Further, according to the information processing system 1, for example, a record (for example, a learning log) relating to learning of one learned model can be acquired on the basis of the distributed ledger 4122 in which the transaction related to the relevance information is stored. In the information processing system 1, a transaction related to one learned model, a transaction related to one learning data, and a transaction related to one learned source code are stored in a distributed ledger. Therefore, according to the information processing system 1, it is possible to ensure that one learned model, one learning data used for learning the one learned model, and one learning source code are not tampered with.

### First Modification

The transaction related to the relevance information and the transaction related to the learning data may be stored in the same distributed ledger. For example, a transaction related to the relevance information and a transaction related to the learning data may be stored in the distributed ledger 4122 realized by the distributed network 40. Alternatively, a transaction related to the relevance information and a transaction related to the learning data may be stored in the distributed ledger realized by the distributed network 60. In addition to the transaction related to the relevance information and the transaction related to the learning data, either or both of the transaction related to the source code for learning and the transaction related to the learned model may be stored in the same distributed ledger.

### Second Modification

The transaction related to the relevance information and the transaction related to the source code for learning may be stored in the same distributed ledger. For example, the distributed ledger 4122 implemented by the distributed network 40 may store a transaction related to the relevance information and a transaction related to the source code for learning. Alternatively, a transaction related to the relevance information and a transaction related to the source code for learning may be stored in the distributed ledger realized by the distributed network 70. In addition to the transaction related to the relevance information and the transaction related to the learning source code, either or both of the transaction related to the learning data and the transaction related to the learned model may be stored in the same distributed ledger.

### Third Modification

The transaction for the relevance information and the transaction for the learned model may be stored in the same distributed ledger. For example, a transaction related to the relevance information and a transaction related to the learned model may be stored in the distributed ledger 4122 realized by the distributed network 40. Alternatively, a transaction related to the relevance information and a transaction related to the learned model may be stored in the distributed ledger realized by the distributed network 50. In addition to the transaction related to the relevance information and the transaction related to the learned model, either or both of the transaction related to the learning data and the transaction related to the learning source code may be stored in the same distributed ledger.

### Fourth Modification

The user of the information processing system 1 may instruct the management server 10 via the terminal 30 to register, for example, one learned model and one inference source code (that is, a source code for performing inference using one learned model). In this case, the processor 11 of the management server 10 may generate a transaction related to one learned model and a transaction related to one inference source code. The processor 11 may further generate a transaction for relevance information indicating a relevance between the one learned model and the one inference source code.

The transaction related to the relevance information may include information about one learned model and information about one inference source code (e.g., identification information for identifying one inference source code). That is, the association between the one learned model and the one inference source code may be indicated by the transaction related to the relevance information including the information related to the one learned model and the information related to the one inference source code. Note that the transaction related to the relevance information may include, in addition to the information related to one learned model and the information related to one inference source code, information related to one learning data used for learning of one learned model and each of one learned source code.

It should be noted that the transaction for one inference source code may be stored in a distributed ledger implemented by a distributed network different from the distributed networks 40, 50, 60, and 70. Note that the transaction related to one inference source code may be stored in a distributed ledger realized by the distributed network 40, 50, 60, or 70.

Various aspects of the disclosure derived from the embodiments and modifications described above are described below.

An information processing system according to an aspect of the present disclosure includes:
A first distributed network for implementing a first distributed ledger;
The first transaction about the relevance information indicating the relevance between the one learned model and either or both of the learning data and the first source code that are used for learning of the learned model are stored in the first distributed ledger
It is called. In the above-described embodiment, the “distributed network 40” corresponds to an example of the “first distributed network”, and the “learning source code” corresponds to an example of the “first source code”.

The first transaction may include first information about the one learned model and either or both of second information about the learning data and third information about the first source code.

The first distributed ledger may further store at least one of the following transactions: a second transaction about the one learned model, a third transaction about the learning data, and a fourth transaction about the first source code.

The information processing system may include a second distributed network for implementing a second distributed ledger different from the first distributed ledger. The second distributed ledger may store at least one of the following reactions: a second transaction about the one learned model, a third transaction about the learning data, and a fourth transaction about the first source code. In the above-described embodiment, at least one of the “distributed networks 50, 60, and 70” corresponds to an example of a “second distributed network”.

The relevance information may further indicate a relevance between the one learned model and a second source code for performing inference using the one learned model.

An information processing system according to another aspect of the present disclosure includes a generation unit that generates a first transaction about relevance information indicating relevance between the learned model and either or both of learning data and a first source code that are used for learning of the learned model. The information processing system further includes a storage unit configured to store the first transaction in a first distributed ledger. In the above-described embodiment, the “management server 10” corresponds to an example of a “generation unit”, and the “node 41” corresponds to an example of a “storage unit”.

The present disclosure is not limited to the above-described embodiments. The present disclosure can be appropriately modified within the scope and spirit of the disclosure that can be read from the claims and the entire specification, and an information processing system accompanied by such modification is also included in the technical scope of the present disclosure.

What is claimed is:

1. An information processing system, comprising a first distributed network that implements a first distributed ledger, wherein a first transaction is stored in the first distributed ledger, the first transaction being a transaction about relevance information indicating relevance between one learned model and either or both of learning data and a first source code that are used for learning of the one learned model.

2. The information processing system according to claim 1, wherein the first transaction includes first information about the one learned model and either or both of second information about the learning data and third information about the first source code.

3. The information processing system according to claim 1, wherein at least one of the following transactions is further stored in the first distributed ledger: a second transaction about the one learned model, a third transaction about the learning data, and a fourth transaction about the first source code.

4. The information processing system according to claim 1, further comprising a second distributed network that implements a second distributed ledger different from the first distributed ledger, wherein at least one of the following transactions is stored in the second distributed ledger: a second transaction about the one learned model, a third transaction about the learning data, and a fourth transaction about the first source code.

5. The information processing system according to claim 1, wherein the relevance information further indicates relevance between the one learned model and a second source code for performing inference using the one learned model.
